(19) United States
(12) Patent Application Publication
(10) Pub. No.: US 2026/0246284 A1
(43) Pub. Date: Aug. 20, 2026

(54) BATTERY CHARGING SYSTEM, BATTERY CHARGING CONTROL METHOD, AND BATTERY CHARGING CONTROL DEVICE

(71) Applicant: Hitachi, Ltd., Tokyo (JP)

(72) Inventors: Satoru KANEKO, Tokyo (JP); Kengo KUMANO, Tokyo (JP); Astushi SHIMADA, Tokyo (JP); Shogo NAMBA, Tokyo (JP); Akeshi TAKAHASHI, Tokyo (JP)

(73) Assignee: Hitachi, Ltd., Tokyo (JP)

(21) Appl. No.: 19/159,430

(22) PCT Filed: Apr. 4, 2024
(86) PCT No.: PCT/JP2024/013886

§ 371 Date: Aug. 25, 2025

(30) Foreign Application Priority Data
Apr. 26, 2023 (JP) 2023-072152

(51) Int. Cl. H02J 7/14; H02J 1/08

(52) U.S. Cl. CPC H02J 7/143; H02J 1/084; H02J 2207/20

(57) ABSTRACT

The power output from multiple power generation modules can be effectively managed by a battery charging control device that includes a major control unit, which increases the converter's output power in the main module by subtracting the battery voltage from a predetermined battery voltage command value, and a secondary control unit that adjusts each secondary module's power output to closely match its respective secondary power command value.

### TECHNICAL FIELD

The present invention relates to a battery charging system, a battery charging control method, and a battery charging control device.

### BACKGROUND ART

As background art of the present technical field, the following PTLs 1 and 2 describe techniques for managing power output from a plurality of power supply devices.

### CITATION LIST

### Patent Literature

PTL 1: JP 2006-298330 A
PTL 2: JP 2013-055839 A

### SUMMARY OF INVENTION

### Technical Problem

By the way, in the above-described technology, there is a demand for more appropriate management of power output from a plurality of power supply devices (power generation modules).

The present invention has been made in view of the above circumstances, and an object of the present invention is to provide a battery charging system, a battery charging control method, and a battery charging control device capable of appropriately managing power output from a plurality of power generation modules.

### Solution to Problem

In order to solve the above problems, a battery charging system according to the present invention includes a plurality of power generation modules each including an engine, a generator driven by the engine, and a converter that converts a voltage output from the generator into a charging voltage and supplies the charging voltage to a battery to be charged, and a battery charging control device that controls the power generation modules. The battery charging control device includes a function assignment unit that selects one of the power generation modules as a major module according to predicted charging power that is power predicted to be supplied to the battery, and selects one or a plurality of the power generation modules other than the major module to be used for charging the battery as a secondary module, a power command unit that outputs a secondary power command value that is a command value of power generated by each of the secondary modules, a major control unit that increases output power of the converter in the major module as a result obtained by subtracting a battery voltage, which is a voltage of the battery, from a predetermined battery voltage command value for the major module increases, and a secondary control unit that brings power output from each of the secondary modules close to the corresponding secondary power command value.

### Advantageous Effects of Invention

According to the present invention, it is possible to appropriately manage the power output from the plurality of power generation modules.

### BRIEF DESCRIPTION OF DRAWINGS

FIG. 1 is a block diagram illustrating a configuration of a distributed battery charging system according to a first embodiment.

FIG. 2 is a diagram illustrating an example of a battery voltage and a charging current.

FIG. 3 is a block diagram of a computer.

FIG. 4 is a diagram illustrating an example of a fuel consumption map of an engine.

FIG. 5 is a block diagram of a control system of a sub-controller in a comparative example.

FIG. 6 is a block diagram of a control system according to the first embodiment.

FIG. 7 is a block diagram of a major control unit.

FIG. 8 is a block diagram of a secondary control unit.

FIG. 9 is a flowchart of main control processing.

FIG. 10 is a flowchart of sub-control processing.

FIG. 11 is a diagram illustrating an example of charging power and fuel efficiency in the first embodiment.

FIG. 12 is a block diagram of a control system according to a second embodiment.

### DESCRIPTION OF EMBODIMENTS

### Outline of Embodiment

With the progress of the expansion of renewable energy for the decarbonization of energy, the importance of an adjustment power generation system using a renewable energy derived fuel (hereinafter, referred to as RE fuel) such as hydrogen in order to cope with the power fluctuation is increasing. While large-scale gas-fired power generation can be utilized as adjustment power, its output adjustment range is often limited to the range of 30% to 100% of the rated operation, and does not become a sufficient adjustment force. In addition, since the installation place of the large-scale thermal power generation facility is fixed, power line reinforcement is required, and the facility cost increases. Furthermore, since the procurement range of fuel to be used in large-scale thermal power generation facilities is limited, it is difficult to effectively utilize RE fuel that is ubiquitous in the region.

A distributed power generation system utilizing an engine generator compatible with RE fuel is promising as a system capable of coping with fluctuations in renewable energy while utilizing RE fuel that is ubiquitous in a region. In particular, it is possible to minimize initial facility cost by utilizing mass production engines such as existing automobile engines and industrial engines, and combining a plurality of them to use as a stationary power generation system. Furthermore, as one of the loads on the engine power generation system, electric vehicles (EV) are expected to increase in the future. A battery mounted on an electric vehicle may be considered to be almost a lithium battery (storage battery with high energy density), and in such a new battery, it is necessary to control the voltage with high accuracy with a wide output change range from a large output range in an early stage of charging to a small output range in a late stage of charging.

Therefore, in the power generation system using the engine as the drive source, it is preferable to first execute power generation with a good fuel economy of the engine from the large output range to the small output range. When the technique of PTL 1 described above is applied, it is considered that the system can be operated while applying an operating point that is as efficient as possible. That is, in a case where low cost supply power such as regenerative power is available in a power supply system for a vehicle, it is considered that the average power cost can be reduced by increasing the utilization degree thereof. This technique is considered to enable effective use of inexpensive generated power generated by regenerative power generation or the like while suppressing frequent charging and discharging of the battery.

Furthermore, when the technology of PTL 2 described above is applied, it is considered that a power supply system including a plurality of power supply devices and an integrated control unit capable of integrally controlling each power supply device according to the total requested power generation can be constructed. That is, it is considered that at least one power supply device among the plurality O power supply devices is selected, and the voltage control unit in the selected power supply device can be controlled so that the selected power supply device generates the maximum generated power equal to or less than the total requested power at the generator rotation speed. According to this technology, it is considered that a plurality of power supply devices using a generator can be operated with less energy consumed, and power corresponding to the total requested power generation can be generated by the plurality of power supply devices.

Among the above techniques, a technique to which PTL 1 is applied is intended to reduce energy consumption by increasing power of a load in an operating state with good power cost in a power supply system, that is, in a regenerative state. Therefore, when it is intended to improve engine efficiency (fuel economy) at the time of power generation in the engine generator, it is difficult to achieve the object. In addition, a technique to which PTL 2 is applied controls the voltage of each of the power storage devices connected to the plurality of power supply devices. Therefore, in a power generation system in which a specific battery is controlled by a plurality of power generation modules, it is difficult to achieve the purpose of charging the battery with high accuracy while operating each power generation module with high efficiency. Therefore, an embodiment described below provides a control device that realizes high power generation efficiency and highly accurate charging of a connected battery in a distributed charging system including a plurality of engine power generation modules.

### First Embodiment

### Hardware Configuration of First Embodiment

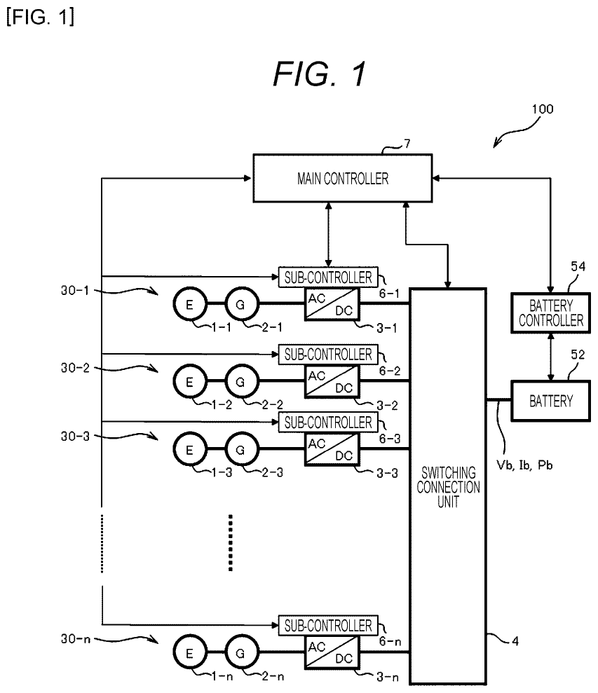

FIG. 1 is a block diagram illustrating a configuration of a distributed battery charging system 100 according to a first embodiment.

In FIG. 1, the distributed battery charging system 100 includes a switching connection unit 4, a main controller 7 (charging control device), and a plurality of (n) power generation modules 30-1 to 30-n. In the following description, a plurality of constituent elements, information, and the like having the same or similar functions and meanings may be denoted by attaching hyphen (‘-’) and alphanumeric characters to the same reference numeral, for example, “power generation modules 30-1 and 30-2”. However, in a case where it is not necessary to distinguish the plurality of constituent elements and the like, for example, as in “power generation module 30”, “-” and alphanumeric characters may be omitted.

The distributed battery charging system 100 is connected to a battery 52 and a battery controller 54. The battery 52 may be a battery for a power facility or a battery for a moving body such as an electric vehicle. The voltage of the battery 52 is referred to as a battery voltage Vb, the current supplied from the distributed battery charging system 100 to the battery 52 is: referred to as a charging current Ib, and the product thereof is referred to as a charging power Pb. The battery controller 54 measures the battery voltage Vb, the charging current Ib, and other various states of the battery 52, and supplies the results to the main controller 7.

Each of the power generation modules 30-1 to 30-n includes engines 1-1 to 1-n, generators 2-1 to 2-n, converters 3-1 to 3-n which are AC/DC converters, and sub-controllers 6-1 to 6-n (charging control device). The switching connection unit 4 selects one or a plurality of power generation modules 30, and supplies power output from the selected power generation module 30 to the battery 52. The battery controller 54 performs various controls on the battery 52.

Each sub-controller 6 transmits and receives various command signals and state signals to and from the main controller 7 located in the host system. The main controller 7 communicates with the switching connection unit 4 to control and monitor the switching/connection state of the power generation module 30. In addition, the main controller 7 establishes communication with the battery controller 54. As a result, the main controller 7 collects data such as specifications and a charge state of the battery 52 from the battery controller 54 as needed, and executes control according to the charge state of the battery 52. The battery 52 is, for example, a lithium ion battery.

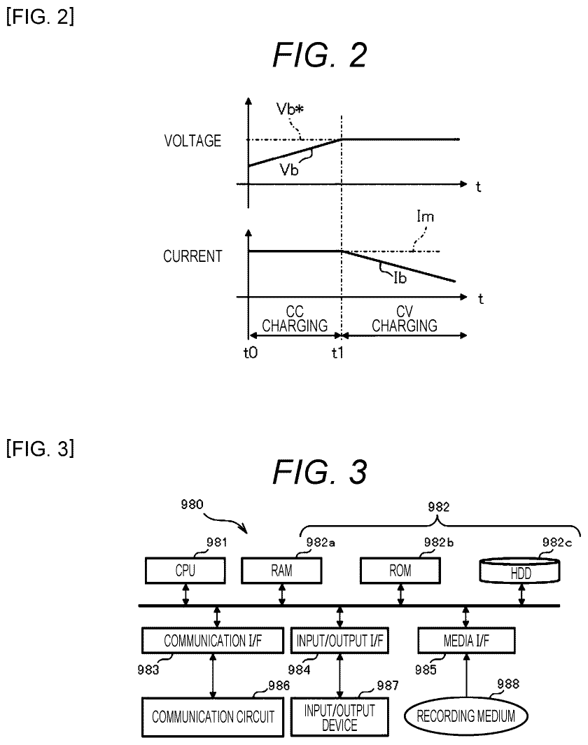

FIG. 2 is a diagram illustrating an example of the battery voltage Vb and the charging current Ib.

In a case where the battery 52 (see FIG. 1) which is a lithium ion battery is charged, the sub-controller 6 and the main controller 7 perform control such that the battery 52 is charged in a constant current (CC) charging mode in the first CC charging period. In the example of FIG. 2, the period from time to t0 time t1 is the CC charging period, and in this period, the charging current Ib matches a predetermined limited current value Im (for example, rated current), and the charging power becomes relatively large. The battery voltage Vb gradually approaches the predetermined battery voltage command value Vb*, that is, the charge completion voltage.

Next, when the battery voltage Vb reaches the battery voltage command value Vb*, the sub-controller 6 and the main controller 7 perform control such that the battery 52 is charged in a constant voltage (CV) charging mode in a CV charging period. In the example of FIG. 2, a period after time t1 is the CV charging period. In this period, the sub-controller 6 and the main controller 7 control the charging current Ib so as to maintain the battery voltage Vb at the battery voltage command value Vb*. Therefore, in the CV charging period, the charging power is relatively small, and the charging current Ib decreases with the lapse of time.

FIG. 3 is a block diagram of a computer 980. Each of the sub-controller 6, the main controller 7, and the battery controller 54 illustrated in FIG. 1 includes one or more computers 980 illustrated in FIG. 3.

In FIG. 3, the computer 980 includes a CPU 981, a storage unit 982, a communication interface (I/F) 983, an input/output I/F 984, and a media I/F 985. Here, the storage unit 982 includes a RAM 982a, a ROM 982b, and an HDD 982c. The communication I/F 983 is connected to a communication circuit 986. The input/output I/F 984 is connected to an input/output device 987. The media I/F 985 reads and writes data to and from a recording medium 988.

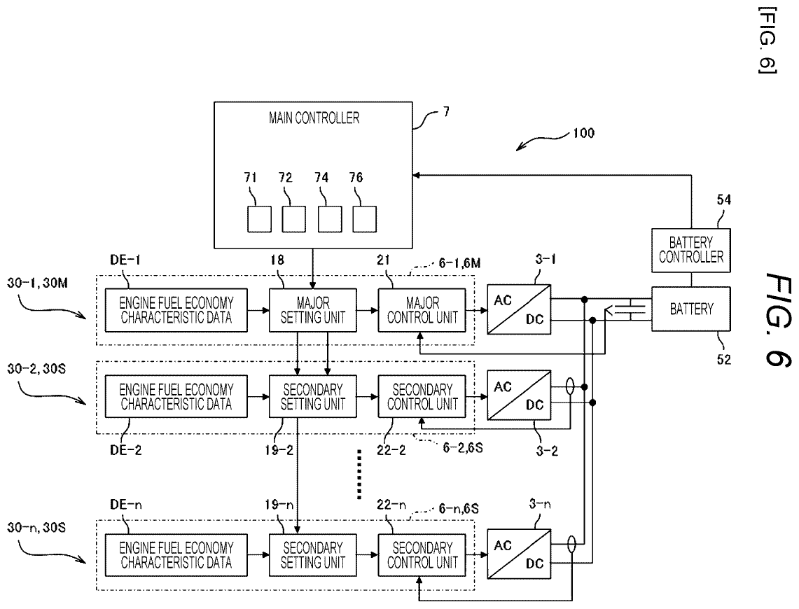

The ROM 982b stores an initial program loader (IPL) and the like executed by the CPU. The HDD 982c stores a control program, various data, and the like. The CPU 981 implements various functions by executing a control program and the like read from the HDD 982c into the RAM 982a. An internal configuration (see FIGS. 6, 7, and 8), which will be described later, of the sub-controller 6, the main controller 7, and the like indicates functions realized by a control program and the like as blocks.

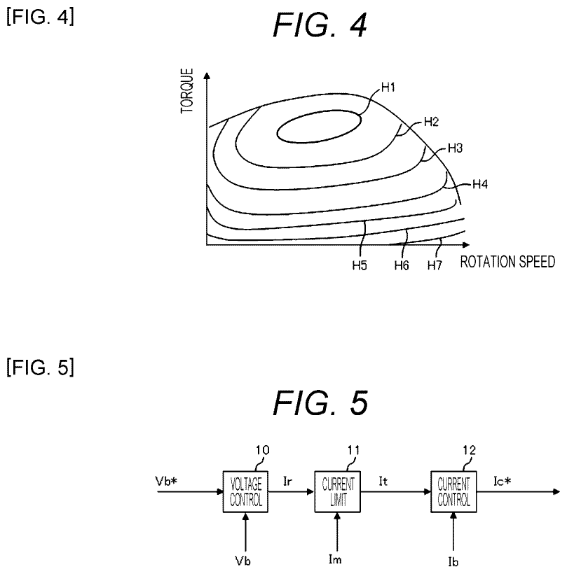

FIG. 4 is a diagram illustrating an example of a fuel consumption map of an engine 1.

For example, diesel engines and the like used in the industrial field and the transportation field have characteristics like the fuel consumption map illustrated in FIG. 4. The engine 1 (see FIG. 1) according to the present embodiment also has similar characteristics.

In FIG. 4, the horizontal axis represents the rotation speed of the engine, and the vertical axis represents the torque. In FIG. 4, contour lines H1 to H7 connect operating points having the same fuel consumption (fuel economy), and the fuel economy according to these contour lines has a relationship of H1<H2<H3<H4<H5<H6<H7. As illustrated in the drawing, the fuel economy tends to be low at an operating point with a large output, and the fuel economy tends to be high at an operating point with a small output.

Although details will be described later, in the present embodiment, the engine 1 of each of the power generation modules 30 generates power at an operating point at which the fuel economy is near the best, so that the efficiency of the entire system is brought close to the maximum value. Here, as illustrated in FIG. 2, the charging current Ib gradually decreases in the CV charging period. If the required power for charging is generated using one power generation module 30, the fuel consumption increases in the late stage of charging, and excess fuel is consumed. On the other hand, in the distributed battery charging system 100 of the present embodiment, the optimum combination of the power generation module 30 for the necessary charging current Ib can be applied. This enables the distributed battery charging system 100 to always generate power with a fuel economy close to the best during the entire charging period.

### Comparative Examples

Here, before describing the operation of the first embodiment, a comparative example will be described.

The hardware configuration of the comparative example is similar to that of the first embodiment (see FIG. 1). However, in the present comparative example, the main controller 7 and the switching connection unit 4 are different in that only one power generation module 30 is selected and connected to the battery 52. FIG. 5 is a block diagram of a control system of the sub-controller 6 in the comparative example.

The sub-controller 6 of the comparative example includes a voltage control unit 10, a current limiting unit 11, and a current control unit 12.

The voltage control unit 10 subtracts the battery voltage Vb from the battery voltage command value Vb* that is the battery voltage Vb when the charging of the battery 52 is completed, and outputs a current request value Ir that increases as the subtraction result increases. The current limiting unit 11 outputs a current target value It that becomes the limited current value Im in a case where the current request value Ir exceeds a predetermined limited current value Im, and becomes the current request value Ir in other cases. Here, as illustrated in FIG. 2, the limited current value Im is, for example, a rated current value of the charging current Ib.

The current control unit 12 outputs a current command value Ic* with which the charging current Ib approaches the current target value It to the converter 3 (see FIG. 1). The converter 3 outputs a current corresponding to the current command value Ic* to the battery 52. When the battery voltage Vb is relatively low, that is, when the state of charge (SOC) is low, the current request value Ir (see FIG. 5) increases, but the current target value It is limited by the current limiting unit 11, and thus the current target value It is equal to the limited current value Im. As a result, the sub-controller 6 (see FIG. 5) executes control of the CC charging mode.

That is, the current control unit 12 outputs the current command value Ic* to the converter 3 so as to realize the current target value It output by the current limiting unit 11=the limited current value Im. Thereafter, when charging progresses, the battery voltage Vb rises, and the SOC rises, the battery voltage Vb eventually reaches the battery voltage command value Vb* (see FIG. 2). As a result, when the current request value Ir decreases, the current target value It and the current request value Ir match, and the control of the sub-controller 6 shifts to the CV charging mode.

As described above, in the present comparative example, only one power generation module 30 is connected to the battery 52 via the switching connection unit 4. This is because, when the plurality 41 power generation modules 30 are connected to the battery 52 through the switching connection unit 4, there is a possibility that control systems (see FIG. 5) in the power generation modules 30 interfere with each other to cause pulsation in charging power.

### Control System of First Embodiment

FIG. 6 is a block diagram of a control system according to the first embodiment.

The main controller 7 includes an information acquisition unit 71, a function assignment unit 72, a power command unit 74, and an output change suppression unit 76.

The information acquisition unit 71 acquires various types of information from the power generation modules 30-1 to 30-n and the battery controller 54.

In addition, the function assignment unit 72 selects at least two power generation modules 30 to be used for charging the battery 52 among all the power generation modules 30. In the example of FIG. 6, it is assumed that all the power generation modules 30-1 to 30-n are selected as the power generation module 30 for charging. Further, the function assignment unit 72 selects one of the power generation modules 30 for charging as a major module 30M, and selects the other power generation modules 30 as secondary modules 30S. In the illustrated example, it is assumed that the power generation module 30-1 is selected as the major module 30M, and the other power generation module 30-k (where 2≤k≤n) is selected as the secondary module 30S.

Here, as the charging of the battery 52 progresses, the charging current Ib that can be supplied to the battery 52 decreases. Therefore, the function assignment unit 72 decreases the number of secondary modules 30S according to the decrease in the charging current Ib. In addition, the function assignment unit 72 also has a function of setting any secondary module 30S as a new major module 30M when the major module 30M stops for some reason.

The power command unit 74 calculates predicted charging power Pbest (not illustrated), which is a predicted value of the charging power Pb, based on the capacity of the battery 52, the current battery voltage Vb, the charging current Ib, the state of charge rate, and the like. In addition, the power command unit 74 calculates predicted major power Pmest (not illustrated), which is a predicted value of output power at which a good fuel economy (less than or equal to a predetermined threshold) can be obtained, based on the engine fuel economy characteristic data DE of the major module 30M.

In addition, the power command unit 74 determines a result obtained by subtracting the predicted major power Pmest from the predicted charging power Pbest as a total secondary power command value Psa* which is the sum of the powers to be generated by all the secondary modules 30S. Further, the power command unit 74 allocates the total secondary power command value Psa* to each secondary module 30S, that is, the power generation module 30-k (where 2<k<n) in the example of FIG. 6, and determines a secondary power command value Pk* which is a command value of the power output from each power generation module 30-k.

In other words, the total secondary power command value Psa* is the sum of the secondary power command values Pk*. When determining the secondary power command value Pk* for each secondary module 30S, the power command unit 74 determines the secondary power command value Pk* based on the engine fuel economy characteristic data DE so that a good fuel economy (less than or equal to a predetermined threshold) can be realized.

When the output of any one of the power generation modules 30 decreases for some reason, the output change suppression unit 76 increases the output of another power generation module 30 or designates any one of power generation modules 30 in the non-output state as a new secondary module 30S. As a result, the output change suppression unit 76 suppresses a change in the charging power supplied to the battery 52.

The sub-controller 6 in the major module 30M, that is, the sub-controller 6-1 in the illustrated example is referred to as a major controller 6M, and the sub-controller 6 in the secondary module 30S, that is, the sub-controller 6-k (where 2≤k≤n) in the illustrated example is referred to as a secondary controller 6S.

The sub-controllers 6-1 to 6-n store engine fuel economy characteristic data DE-1 to DE-n related to the engines 1-1 to 1-n controlled by the sub-controllers. The engine fuel economy characteristic data DE represents a fuel consumption map of the engine 1 (see FIG. 4) in a table format or the like. Each sub-controller 6 supplies the engine fuel economy characteristic data DE in the sub-controller 6 to the main controller 7.

The major controller 6M includes a major setting unit 18 and a major control unit 21. In other words, when the power generation module 30-1 is designated as a major module 30M, the sub-controller 6-1 that has become the major controller 6M enables the functions of major setting unit 18 and major control unit 21.

In addition, the secondary controller 6S, that is, the sub-controller 6-k (where 2>k≤n) includes a secondary setting unit 19-k and a secondary control unit 22-k, respectively. That is, when the power generation module 30-k is designated as the secondary module 30S, the sub-controller 6-k that has become the secondary controller 6S enables the functions of the secondary setting unit 19-k and the secondary control unit 22-k.

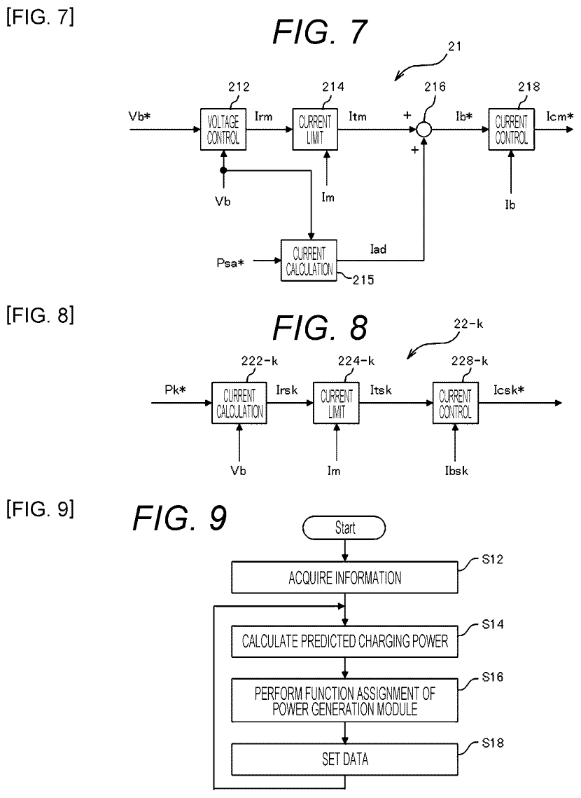

FIG. 7 is a block diagram of the major control unit 21.

In FIG. 7, the major control unit 21 includes a voltage control unit 212 (major voltage control unit), a current limiting unit 214 (major current limiting unit), a current calculation unit 215 (addition current calculation unit), an adder 216, and a current control unit 218 (major current control unit). The voltage control unit 212 subtracts the battery voltage Vb from the battery voltage command value Vb*, and outputs a major current request value Irm that increases as the subtraction result increases.

In addition, the current limiting unit 214 outputs a major current target value Itm that becomes the limited current value Im when the major current request value Irm exceeds the limited current value Im (see FIG. 2), and becomes the major current request value Irm in other cases. The current calculation unit 215 outputs a current addition command value Iad that is an estimated value of the sum of the output currents of the secondary modules 30S based on the total secondary power command value Psa* and the battery voltage Vb described above.

The adder 216 adds the major current target value Itm and the current addition command value Iad, and outputs the addition result as a charging current command value Ib*. The current control unit 218 outputs a major current command value Icm* to the converter 3-1 so that the charging current Ib approaches the charging current command value Ib*.

As a result, the converter 3-1 outputs a current corresponding to the major current command value Icm*. In other words, the major control unit 21 has a function of increasing the output power of the major module 30M as a result of subtracting the battery voltage Vb from the battery voltage command value Vb* increases. Since the power output from the major module 30M has a value close to the predicted major power Pmest calculated by the power command unit 74, a good fuel economy can be obtained in the engine 1 in the major module 30M.

FIG. 8 is a block diagram of the secondary control unit 22-k.

In FIG. 8, the secondary control unit 22-k includes a current calculation unit 222-k (secondary current calculation unit), a current limiting unit 224-k (secondary current limiting unit), and a current control unit 228-k (secondary current control unit). The current calculation unit 222-k outputs a secondary current request value Irsk, which is a current value that realizes the secondary power command value Pk*, based on the secondary power command value Pk* and the battery voltage Vb.

The current limiting unit 224-k outputs a secondary current target value Itsk that becomes the limited current value Im when the secondary current request value Irsk exceeds the limited current value Im, and becomes the secondary current request value Irsk in other cases. Based on the output current Ibsk of the converter 3-k and the secondary current target value Itsk, the current control unit 228-k outputs a secondary current command value Icsk* to the converter 3-k so that the output current Ibsk approaches the secondary current target value Itsk.

The converter 3-k outputs a current corresponding to the secondary current command value Icsk* to the battery 52. As described above, the secondary control unit 22-k has a function of bringing the power output from each of the secondary modules 30S close to the corresponding secondary power command value Pk*.

FIG. 9 is a flowchart of main control processing.

When the battery 52 and the battery controller 54 are connected to the distributed battery charging system 100 of the present embodiment, the main controller 7 starts processing of this routine.

When the process proceeds to step S12 in FIG. 9, the information acquisition unit 71 (see FIG. 6) of the main controller 7 acquires various types of information from the battery controller 54 and the sub-controller 6.

That is, the information acquisition unit 71 acquires the charge completion voltage of the battery 52 and the limited current value Im (see FIG. 2) from the sub-controller 6. Then, the information acquisition unit 71 sets the acquired charge completion voltage to the battery voltage command value Vb*. In addition, the information acquisition unit 71 acquires the engine fuel economy characteristic data DE for the corresponding engine 1 from each power generation module 30.

Next, when the process proceeds to step S14, the power command unit 74 calculates predicted charging power Pbest, which is a predicted value of the charging power Pb, based on the current state of the battery 52. Next, when the process proceeds to step S16 (function assignment procedure), the function assignment unit 72 performs function assignment to the power generation module 30 based on the predicted charging power Pbest. That is, the function assignment unit 72 selects one for charging from among all the power generation modules 30, selects one major module 30M from the power generation modules 30 for charging, and selects the rest as the secondary modules 30S.

Next, when the process proceeds to step S18 (power command procedure), the power command unit 74 performs various data settings on each power generation module 30. That is, the power command unit 74 calculates the predicted major power Pmest, and determines a result obtained by subtracting the predicted major power Pmest from the predicted charging power Pbest as the total secondary power command value Psa*. Next, the power command unit 74 determines the secondary power command value Pk* by allocating the total secondary power command value Psa* to each secondary module 30S so that a good fuel economy (less than or equal to a predetermined threshold) can be realized.

Next, the power command unit 74 supplies the total secondary power command value Psa*, the battery voltage command value Vb*, the limited current value Im, and the charging current Ib to the major controller 6M. In addition, the power command unit 74 supplies the secondary power command value Pk* and the limited current value Im to each secondary controller 6S.

Thereafter, the process returns to step S14, and the processes of steps S14 to S18 are repeated. When the charging current Ib gradually decreases in the procedure, the function assignment unit 72 decreases the number of secondary modules 30S in step S16.

Although not illustrated, the main controller 7 sequentially determines whether the charging of the battery 52 is completed based on whether the charging current Ib is less than a predetermined value. When the charging current Ib becomes less than the predetermined value, the main controller 7 stops each power generation module 30 via each sub-controller 6.

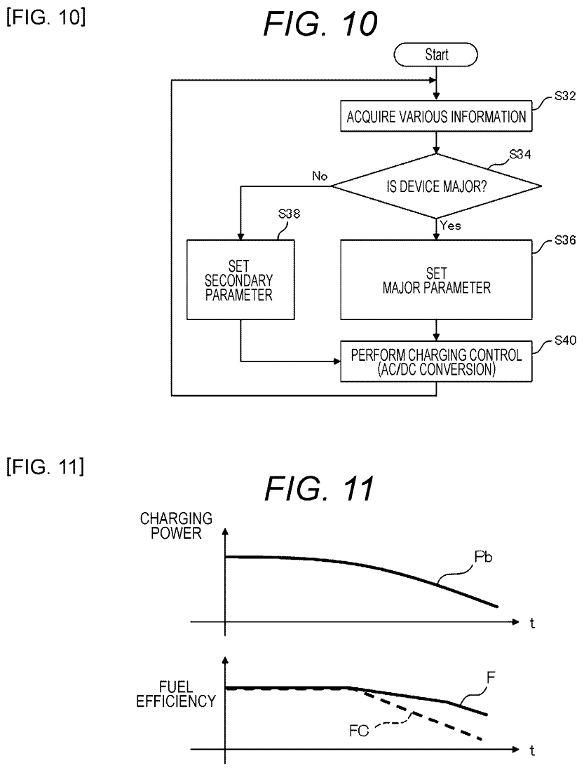

FIG. 10 is a flowchart of the sub-control processing.

When the battery 52 and the battery controller 54 are connected to the distributed battery charging system 100 of the present embodiment, the sub-controller 6 starts processing of this routine.

When the process proceeds to step S32 in FIG. 10, the sub-controller 6 acquires various types of information from the main controller 7. Next, when the process proceeds to step S34, the sub-controller 6 determines whether the sub-controller 6 is designated as the major controller 6M.

When it is determined as “Yes” in step S34, the process proceeds to step S36 (major control procedure). As described above regarding the process of step S18 (see FIG. 9), the main controller 7 supplies the total secondary power command value Psa*, the battery voltage command value Vb+, the limited current value Im, and the charging current Ib to the major controller 6M. Therefore, in step S36, the major setting unit 18 sets these parameters for the major control unit 21.

On the other hand, when it is determined as “No” in step S34, the process proceeds to step S38 (secondary control procedure). As described above with respect to the process of step S18 (see FIG. 9), the main controller 7 supplies the secondary power command value Pk* and the limited current value Im to the secondary controller 6S. Therefore, in step S38, the secondary setting unit 19-k sets these parameters for the secondary control unit 22-k.

Next, when the process proceeds to step S40 (secondary control procedure, major control procedure), the sub-controller 6 performs charging control on the battery 52. That is, in the major controller 6M, the converter 3-1 is controlled by the algorithm of the major control unit 21 (see FIG. 7). In the secondary controller 6S, the converter 3-k is controlled by the algorithm of the secondary control unit 22-k (see FIG. 8).

Thereafter, the process returns to step S32, and the processes of steps S32 to S40 are repeated. In particular, in the present embodiment, since the determination processing in step S34 is repeatedly executed, the main controller 7 can appropriately switch the function of the sub-controller 6 to the major controller 6M or the secondary controller 6S.

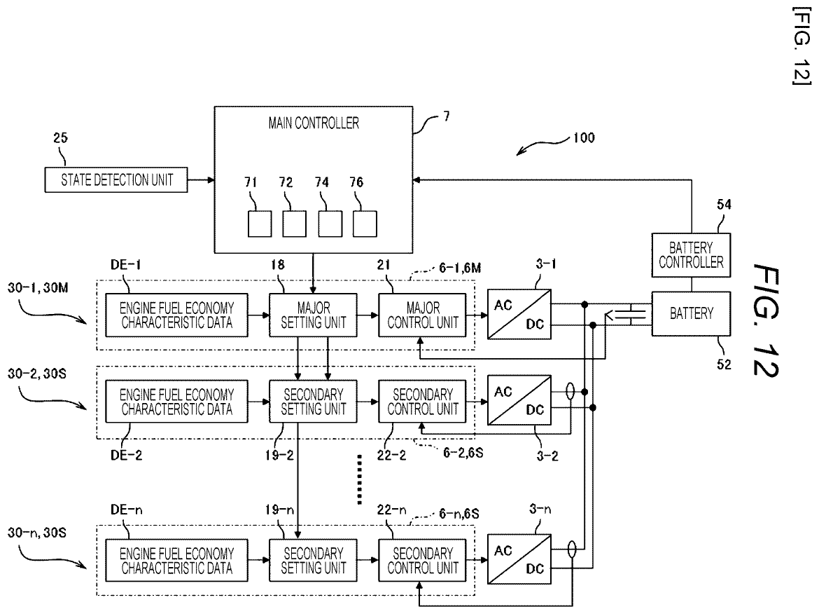

FIG. 11 is a diagram illustrating an example of the charging power Pb and a fuel efficiency F in the first embodiment.

In FIG. 11, a fuel efficiency FC in the comparative example is also indicated by a broken line. The “fuel efficiency” refers to electric energy obtained by a certain fuel, and may be considered to be the reciprocal of the “fuel economy” described above.

As described above, the charging power Pb decreases with the lapse of the time t. In the comparative example in which any one of the power generation modules 30 is fixedly applied, the fuel efficiency FC greatly decreases with the lapse of time. On the other hand, according to the first embodiment, since the function assignment unit 72 decreases the number of power generation modules 30 with the lapse of time, the fuel efficiency F can be maintained at a relatively high level. Further, according to the first embodiment, the control of changing the charging power Pb according to the battery voltage Vb is mainly performed only by the major module 30M. As a result, it is possible to realize highly accurate charging control in which pulsation of the charging power Pb is suppressed.

### Second Embodiment

FIG. 12 is a block diagram of a control system according to the second embodiment. In the following description, portions corresponding to the respective portions of the first embodiment described above are denoted by the same reference numerals, and the description thereof may be omitted.

In the second embodiment, a power generation module state detection unit 25 connected to the main controller 7 is provided. Other configurations are similar to those of the first embodiment (see FIGS. 1 and 6).

The power generation module state detection unit 25 detects the state of each power generation module 30, determines whether a failure has occurred in each power generation module 30, and supplies the result to the main controller 7. As a result, the main controller 7 can appropriately select the power generation module 30 to be operated and the power generation module 30 to be the major module 30M among these.

### Effects of Embodiment

As described above, according to the above-described embodiment, the battery charging system (100) includes: the plurality of power generation modules 30 each including the engine 1, the generator 2 driven by the engine 1, and the converter 3 that converts the voltage output from the generator 2 into a charging voltage and supplies the charging voltage to the battery 52 to be charged; and the battery charging control device (6, 7) that controls the power generation module 30. The battery charging control device (6,7) includes the function assignment unit 72 that selects one power generation module 30 as the major module 30M according to the predicted charging power Pbest that is the power predicted to be supplied to the battery 52, and selects one or a plurality of power generation modules 30 other than the major module 30M to be used for charging the battery 52 as the secondary modules 30S, a power command unit 74 that outputs the secondary power command value Pk* that is a command value of power generated by each secondary module (30-k), the major control unit 21 that increases, for the major module 30M, the output power of the converter 3 in the major module 30M as a result of subtracting the battery voltage Vb that is a voltage of the battery 52 from a predetermined battery voltage command value (Vb*) becomes larger, and a secondary control unit 22-k that brings the power output from each secondary module 30S closer to the corresponding secondary power command value Pk*. As a result, the power output from the plurality of power generation modules can be appropriately managed. That is, high power generation efficiency can be realized by using the plurality of power generation modules, and high-accuracy charging can be realized for the connected battery 52.

Further, it is more preferable that the power command unit 74 determines the secondary power command value Pk* of the secondary module 30S at which the fuel economy equal to or less than the predetermined threshold can be obtained based on the fuel economy characteristic (DE) of the generator 2 of each secondary module 30S. Accordingly, the appropriate secondary power command value Pk* based on the fuel economy characteristic (DE) can be determined.

Further, it is more preferable that the power command unit 74 has a function of calculating the predicted major power Pmest, which is a predicted value of the output power of the major module 30M at which the fuel economy less than or equal to the predetermined threshold can be obtained, based on the fuel economy characteristic (DE) of the generator 2 of the major module 30M, a function of calculating the total secondary power command value Psa*, which is the sum of the secondary power command values Pk*, by subtracting the predicted major power Pmest from the predicted charging power Pbest, and a function of determining the secondary power command value Pk* of the secondary module 30S at which the fuel economy less than or equal to the predetermined threshold can be obtained based on the total secondary power command value Psa* and the fuel economy characteristic (DE) of the generator 2 of each secondary module 30S. As a result, it is possible to determine a more appropriate secondary power command value Pk* based on the fuel economy characteristic (DE), the predicted major power Pmest, and the predicted charging power Pbest.

Further, when the major module 30M stops, the function assignment unit 72 more preferably sets one of the secondary modules 30S as a new major module 30M. As a result, even if the major module 30M stops for some reason, the distributed battery charging system 100 can continue to operate.

Further, it is more preferable that the battery charging control device (6,7) further includes the output change suppression unit 76 that suppresses a change in the charging power supplied to the battery 52 by increasing the output of another power generation module 30 when the output of one of the power generation modules 30 decreases or designating one of the power generation modules 30 in the non-output state as a new secondary module (30-k). As a result, even if the output of any of the power generation modules 30 decreases, it is possible to suppress a change in charging power supplied to the battery 52.

In addition, the function assignment unit 72 determines the number of the secondary modules 30S according to the capacity of the battery 52, and then decreases the number of the secondary modules 30S according to the decrease in the charging current Ib flowing through the battery 52, so that an appropriate number of the secondary modules 30S can be operated according to the decrease in the charging current Ib.

In addition, the major control unit 21 more preferably includes the major voltage control unit (212) that outputs a major current request value Irm that increases as a result of subtracting the battery voltage Vb from the battery voltage command value (Vb*) increases, the addition current calculation unit (215) that outputs the current addition command value Iad corresponding to the sum of the currents output from the secondary module 30S based on the total secondary power command value Psa* that is the sum of the secondary power command values Pk* and the battery voltage Vb, the major current limiting unit (214) that outputs the major current target value Itm that becomes the limited current value Im when the major current request value Irm exceeds a predetermined limited current value Im and becomes the major current request value Irm in other cases, and the major current control unit (218) that controls the output current of the converter (3-1) in the major module 30M such that the charging current Ib flowing to the battery 52 approaches the charging current command value (Ib*) that is the sum of the major current target value Itm and the current addition command value Iad. As a result, the major control unit 21 can more appropriately control the output power of the converter 3 in the major module 30M.

The secondary control unit 22-k more preferably includes the secondary current calculation unit (222-k) that calculates the secondary current request value Irsk in each secondary module 30S based on the secondary power command value Pk* for each secondary module 30S and the battery voltage Vb, the secondary current limiting unit (224-k) that outputs the secondary current target value Itsk that becomes the limited current value Im when each secondary current request value Irsk exceeds the limited current value Im and becomes the corresponding secondary current request value Irsk in other cases, and the secondary current control unit (228-k) that controls the secondary output current (Ibsk) that is an output current of the converter (3-k) in each secondary module 30S so as to approach each secondary current target value Itsk. As a result, the secondary control unit 22-k can more appropriately control the power output from each of the secondary modules 30S.

### Modifications

The present invention is not limited to the above-described embodiments, and various modifications are possible. The above-described embodiments have been described for clear understanding of the present invention, and are not necessarily limited to those having all the described configurations. In addition, some of the configurations of a certain embodiment may be replaced with the configurations of the other embodiments, and the configurations of the other embodiments may be added to the configurations of the embodiment. In addition, some of the configurations of each embodiment may be omitted, or added with other configurations or replaced with other configurations. Only control lines and information lines considered to be necessary for explanation are illustrated in the drawings, but not all the control lines and the information lines necessary for a product are illustrated. In practice, almost all the configurations may be considered to be connected to each other. Possible modifications to the above embodiment are, for example, as follows.
(1) Since the hardware of the sub-controller 6 and the main controller 7 in the above embodiment can be realized by a general computer, the flowcharts illustrated in FIGS. 9 and 10, programs for executing various processes described above, and the like may be stored in a storage medium (computer-readable recording medium in which the programs are recorded) or distributed via a transmission path.
(2) The processes illustrated in FIGS. 9 and 10 and other processes described above have been described as software processes using a program in the above embodiment, but some or all of the processes may be replaced with hardware processes using an application specific integrated circuit (ASIC), a field programmable gate array (FPGA), or the like.
(3) In each of the above embodiments, the power command unit 74 determines the predicted major power Pmest (not illustrated) and the secondary power command value Pk* based on the engine fuel economy characteristic data DE so that a good fuel economy (equal to or less than a predetermined threshold) can be realized. However, instead of using the engine fuel economy characteristic data DE, an output power range in which a good fuel economy (less than or equal to a predetermined threshold) can be realized may be calculated in advance for each power generation module 30, and the predicted major power Pmest (not illustrated) and the secondary power command value Pk* may be determined so as to be included in the output power range.
(4) In the above embodiment, the limited current value Im (see FIG. 7) in the major control unit 21 and the limited current value Im (see FIG. 8) in each secondary control unit 22-k have the same value. However, these limited current values Im may be different values. For example, the rated output current in each power generation module 30 may be set to the limited current value Im.
(5) Various types of processing executed in the above embodiment may be executed by a server computer via a network (not illustrated), and various types of data stored in the above embodiment may also be stored in the server computer.

### REFERENCE SIGNS LIST

1 engine
2 generator
3 converter
6 sub-controller (battery charging control device)
7 main controller (battery charging control device)
21 major control unit
22-k secondary control unit
30 power generation module
30M major Module
30S secondary module
52 battery
72 function assignment unit
74 power command unit
76 output change suppression unit
100 distributed battery charging system (battery charging system)
212 voltage control unit (major voltage control unit)
214 current limiting unit (major current limiting unit)
215 current calculation unit (addition current calculation unit)
218 current control unit (major current control unit)
222-k current calculation unit (secondary current calculation unit)
224-k current limiting unit (secondary current limiting unit)
228-k current control unit (secondary current control unit)
DE engine fuel economy characteristic data (fuel economy characteristic)
Ib charging current
Im limited current value
Vb battery voltage
Pk* secondary power command value
Iad current addition command value
Irm major current request value
Itm major current target value
S16 step (function assignment procedure)
S18 step (power command procedure)
S36 step (major control procedure)
S38 step (secondary control procedure)
S40 step (secondary control procedure, major control procedure)
Psa* total secondary power command value
Ibsk output current (secondary output current)
Irsk secondary current request value
Itsk secondary current target value
Pbest predicted charging power
Pmest predicted major power

1. A battery charging system comprising:
a plurality of power generation modules each including an engine, a generator driven by the engine, and a converter that converts a voltage output from the generator into a charging voltage and supplies the charging voltage to a battery to be charged; and
a battery charging control device that controls the power generation module, wherein
the battery charging control device includes:
a function assignment unit that selects one of the power generation modules as a major module according to predicted charging power that is power predicted to be supplied to the battery, and selects one or a plurality of the power generation modules other than the major module to be used for charging the battery as a secondary module;
a power command unit that outputs a secondary power command value that is a command value of power generated by each of the secondary modules;
a major control unit that increases output power of the converter in the major module as a result obtained by subtracting a battery voltage, which is a voltage of the battery, from a predetermined battery voltage command value for the major module increases; and
a secondary control unit that brings power output from each of the secondary modules close to the corresponding secondary power command value.

2. The battery charging system according to claim 1, wherein the power command unit determines the secondary power command value of the secondary module at which a fuel economy equal to or less than a predetermined threshold can be obtained, based on a fuel economy characteristic of the generator of each of the secondary modules.

3. The battery charging system according to claim 1, wherein the power command unit includes:
a function of calculating predicted major power that is a predicted value of output power of the major module at which a fuel economy equal to or less than a predetermined threshold can be obtained based on a fuel economy characteristic of the generator of the major module;
a function of calculating a total secondary power command value that is a sum of the secondary power command values by subtracting the predicted major power from the predicted charging power; and
a function of determining the secondary power command value of the secondary module at which a fuel economy equal to or less than a predetermined threshold can be obtained based on the total secondary power command value and a fuel economy characteristic of the generator of each of the secondary modules.

4. The battery charging system according to claim 1, wherein when the major module stops, the function assignment unit sets one of the secondary modules as a new major module.

5. The battery charging system according to claim 4, further comprising an output change suppression unit that suppresses a change in charging power supplied to the battery by increasing an output of another power generation module or designating any of the power generation modules in a non-output state as a new secondary module when an output of any of the power generation modules decreases.

6. The battery charging system according to claim 1, wherein the function assignment unit determines a number of the secondary modules according to a capacity of the battery, and then decreases the number of the secondary modules according to a decrease in charging current flowing through the battery.

7. The battery charging system according to claim 5, wherein
the major control unit includes:
a major voltage control unit that outputs a major current request value that increases as a result of subtracting the battery voltage from the battery voltage command value increases;
an addition current calculation unit that outputs a current addition command value corresponding to a sum of currents output from the secondary module based on a total secondary power command value that is a sum of the secondary power command values and the battery voltage;
a major current limiting unit that outputs a major current target value that becomes a predetermined limited current value in a case where the major current request value exceeds the limited current value, and becomes the major current request value in other cases; and
a major current control unit that controls an output current of the converter in the major module such that a charging current flowing through the battery approaches a charging current command value that is a sum of the major current target value and the current addition command value.

8. The battery charging system according to claim 7, wherein the secondary control unit includes:
a secondary current calculation unit that calculates a secondary current request value in each of the secondary modules based on the secondary power command value for each of the secondary modules and the battery voltage;
a secondary current limiting unit that outputs a secondary current target value that becomes the limited current value when each of the secondary current request values exceeds the limited current value, and becomes the corresponding secondary current request value in other cases; and
a secondary current control unit that controls a secondary output current that is an output current of the converter in each of the secondary modules in such a way to approach each of the secondary current target values.

9. A battery charging control method to be applied to a battery charging system including: a plurality of power generation modules each including an engine, a generator driven by the engine, and a converter that converts a voltage output from the generator into a charging voltage and supplies the charging voltage to a battery to be charged; and a battery charging control device that controls the power generation module, the method comprising:
a function assignment procedure of selecting one of the power generation modules as a major module according to predicted charging power that is power predicted to be supplied to the battery, and selecting one or a plurality of the power generation modules other than the major module to be used for charging the battery as a secondary module;
a power command procedure of outputting a secondary power command value that is a command value of power generated by each of the secondary modules;
a major control procedure of increasing output power of the converter in the major module as a result obtained by subtracting a battery voltage, which is a voltage of the battery, from a predetermined battery voltage command value for the major module increases; and
a secondary control procedure of bringing power output from each of the secondary modules close to the corresponding secondary power command value.

10. A battery charging control device comprising:
a function assignment unit that, in order to control a plurality of power generation modules, each of which including an engine, a generator driven by the engine, and a converter that converts a voltage output from the generator into a charging voltage and supplies the charging voltage to a battery to be charged, selects one of the power generation modules as a major module according to predicted charging power that is power predicted to be supplied to the battery, and selects one or a plurality of the power generation modules other than the major module to be used for charging the battery as a secondary module;
a power command unit that outputs a secondary power command value that is a command value of power generated by each of the secondary modules;
a major control unit that increases output power of the converter in the major module as a result obtained by subtracting a battery voltage, which is a voltage of the battery, from a predetermined battery voltage command value for the major module increases; and
a secondary control unit that brings power output from each of the secondary modules close to the corresponding secondary power command value.
